(19) United States
(12) Patent Application Publication
(10) Pub. No.: US 2013/0123026 A1
(43) Pub. Date: May 16, 2013

(54) MAGNETIC DRIVE POWER TRANSFER SYSTEM

(71) Applicant: NORMAN LANE PURDY, Fryeburg, ME (US)

(72) Inventor: NORMAN LANE PURDY, Fryeburg, ME (US)

(21) Appl. No.: 13/477,112

(22) Filed: May 22, 2012

Related U.S. Application Data
(60) Provisional application No. 61/559,755, filed on Nov. 15, 2011.

(51) Int. Cl. F16D 27/14

(52) U.S. Cl. 464/29

(57) ABSTRACT

The modular magnetic rotary drive system includes a first module and a second module. The first module includes a rotating cylindrical body with a plurality of blanks for receiving permanent magnets. The second module includes a plurality of rotating fingers, the number and angular spacing of the fingers matching those of the blanks. The fingers may be made of a ferrous material or configured to receive permanent magnets. The first and second modules can be mated together such that the cylindrical body and the fingers rotate synchronously due to magnetic forces between the magnets and the fingers.

### BACKGROUND OF THE INVENTION

1. Field of the Invention

The present invention relates to a modular magnetic rotary drive system for use in refrigeration systems and other systems in which it is desirable to prevent leakage of fluids through rotary seals.

2. Description of the Related Art

Magnetic drives have long been used in fluid-handling equipment, especially in refrigeration systems and other systems in which leakage of a fluid may cause physical or economic damage. Many of these systems contain multiple fluid moving components, typically requiring separate motors.

Smaller motors may be less efficient than larger motors. Thus, using a single motor to drive several components may result in an increase in efficiency over using a separate motor for each component. Further, using one motor to drive several components may require less space than using separate motors to drive each component.

A need exists for a mating system by which multiple fluid-handling components are driven by a single electric motor or other prime mover. The modular system described herein aims at minimizing the number of prime movers in a system and maximizing efficiency by providing a mating system in which power is transferred from module to module using tandem magnetic drives powering systems such as chillers, refrigeration, air conditioning, dehumidifiers, and liquid pumping equipment.

A further benefit of the system disclosed is that the concentric arrangement of magnetic couplings greatly reduces the axial forces associated with face-to-face arrangements of magnetic couplings, consequently reducing friction and bearing loads.

### SUMMARY OF THE INVENTION

A modular magnetic rotary drive system includes a first module having a first cylindrical body with a plurality of magnet receiving blanks spaced around a first central hub at equal angles and a second module comprising a second cylindrical body having a plurality of fingers spaced around a second central hub at equal angles. The number of fingers is the same as the number of magnet receiving blanks in the first module. The first module and the second module are adapted to mate together such that the first cylindrical body and the second cylindrical body are capable of rotating about a common axis within a common plane.

These and other features of the present invention will become readily apparent upon further review of the following specification and drawings.

### BRIEF DESCRIPTION OF THE DRAWINGS

FIG. 1 is a section view of a modular magnetic rotary drive system;

FIG. 2 is a section view of a male module of the modular magnetic rotary drive system of FIG. 1;

FIG. 3 is a section view of a female module of the modular magnetic rotary drive system of FIG. 1;

FIG. 4 is a view of the modular magnetic rotary drive system with both the male and female modules having removable magnets, the view being along a rotational axis;

FIG. 5 is a sectional view of a stacked compressor, pump, and squirrel cage fan driven by a single motor using the modular magnetic rotary drive system;

FIG. 6 is a section view of an adapter coupling for the modular magnetic rotary drive system; and

FIG. 7 is a section view of a pulley module including a male module and a female module of the modular magnetic rotary drive system.

### DESCRIPTION OF THE REFERENCED NUMERALS

1000 Modular drive system
1100 Male module of modular drive system 1000
1110 Housing for male module 1100
1111 Flange for mounting housing 1110
1112 Bolt holes on flange 1111
1113 O-ring channel on flange 1112
1114 Clip lock channel for housing 1110
1115 Cylindrical portion of housing 1110
1116 Face of housing 1110
1120 Inner disk of male module 1100
1121 Cylindrical hub of inner disk 1120
1122 Magnet holding element
1123 Magnet receiving blanks
1124 Shaft receiving hole
1125 Threaded hole for set screw
1126 Keyway for shaft receiving hole 1124
1130 Magnets
1140 Set screw for mounting inner disk 1120 on drive shaft
1200 Female module of modular drive system 1000
1210 Housing for female module 1200
1211 Cylindrical section of housing 1210
1212 Face of housing 1210
1213 Mounting bolt holes for housing 1210
1214 Clip lock channel for housing 1210
1216 Seal mating face for housing 1210
1217 Shaft passage
1220 Disk coupler for female module 1200
1221 Fingers of disk coupler 1220
1222 Mounting hub for disk coupler 1220
1224 Shaft receiving hole
1230 O-ring
1240 Set screw
1600 Size adapter module
1700 Pulley module
1701 Pulley
1710 Pulley module shaft

### DETAILED DESCRIPTION OF THE PREFERRED EMBODIMENTS

It is to be understood that the present invention is not limited to the embodiments described above, but encompasses any and all embodiments within the scope of the following claims. Practitioners skilled in the art will recognize numerous other embodiments as well. For a definition of the complete scope of the invention, the reader is directed to the appended claims.

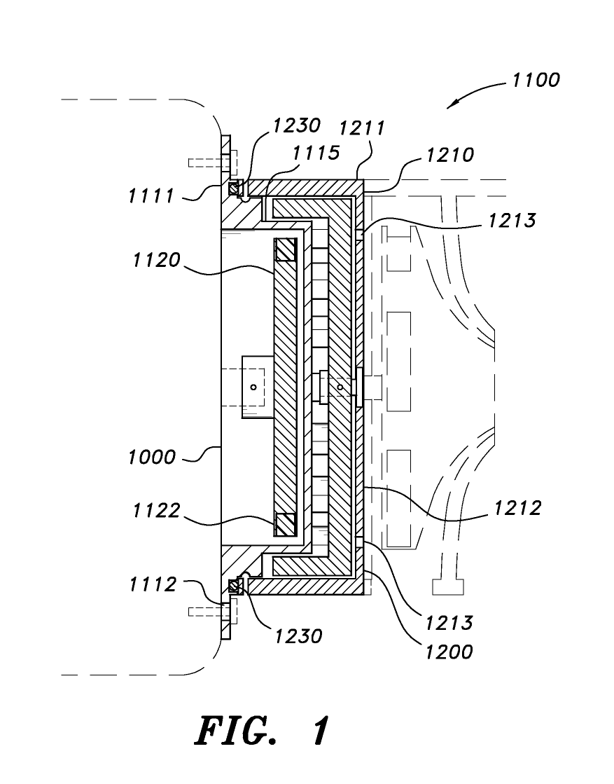

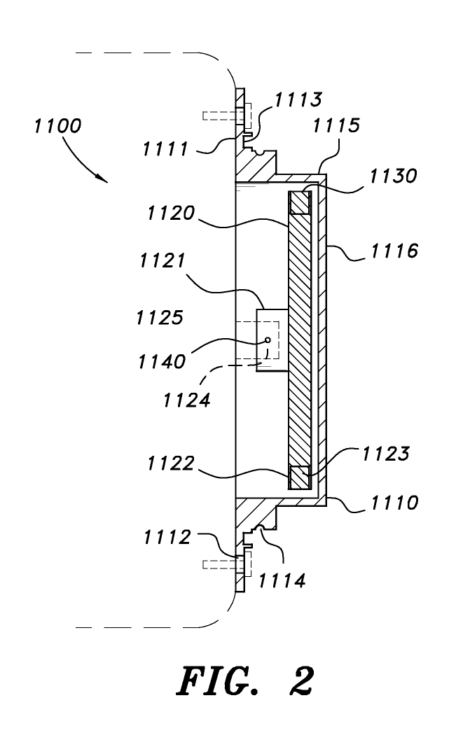

Referring to the accompanying drawings, FIG. 1 shows a section view of a male module 1100 and a female module 1200 of a modular magnetic drive system 1000. Male module 1100 is shown attached to an electric motor (shown in phantom at left of drawing). Female module 1200 is shown attached to a centrifugal pump (shown in phantom at right of drawing). Male module 1100 and female module 1200 may be attached to each other, as described below.

FIG. 2 shows a section view of male module 1100. Male module 1100 may comprise a housing 1110 and inner disk 1120.

Housing 1110 may comprise a circular flange 1111 for mounting housing 1110 to the face of an electric motor or other rotary prime mover. Bolt holes 1112 may be provided in flange 1111 to facilitate attaching housing 1110 to the prime mover. Although bolt holes may be provided, other means known in the art of attaching housing 1110 to a prime mover may be used and accommodated in fabrication of housing 1110.

Flange 1111 of housing 1110 may be provided with an O-ring channel 1113 for sealing male module 1100 to female module 1200. Other means known in the art of providing a fluid-tight seal between two surfaces may be provided instead of, or in addition to, an O-ring seal.

Clip lock channel 1114 may be provided on the outer diameter of cylindrical portion 1115 of housing 1110. Clip lock channel 1114 may facilitate attachment of male module 1100 to female module 1200. Face 1116 of housing 1110 may be located at the end of cylindrical portion 1115 opposite the motor on which it is mounted.

Housing 1110 may be fabricated of a non-ferromagnetic material including, but not limited to, non-ferrous metal, stainless steel, polymers, carbon fiber, or any other material known in the art to provide minimal interference with magnetic fields.

Inner disk 1120 may comprise a cylindrical hub 1121 surrounded by a magnet holding element 1122. Magnet holding element 1122 may be a solid circular structure with magnet receiving blanks 1123, or may be a more skeletal structure providing a framework for holding permanent magnets 1130 while minimizing weight. Magnet receiving blanks 1123 may be in the shape of the magnets 1130 to be received.

Inner disk 1120 may contain, for example, 20 magnet receiving blanks 1123 spaced in a circle at equal angular intervals. With an inner disk 1120 containing 20magnet receiving blanks 1123, 2, 4, 5, 8, 10, 12, 14, 16, 18, or 20 magnets 1130 may be installed. The number of magnets to be used may vary according to the amount of power to be transferred between male module 1100 and female module 1200. The magnets may be installed in a symmetrical pattern to provide balance.

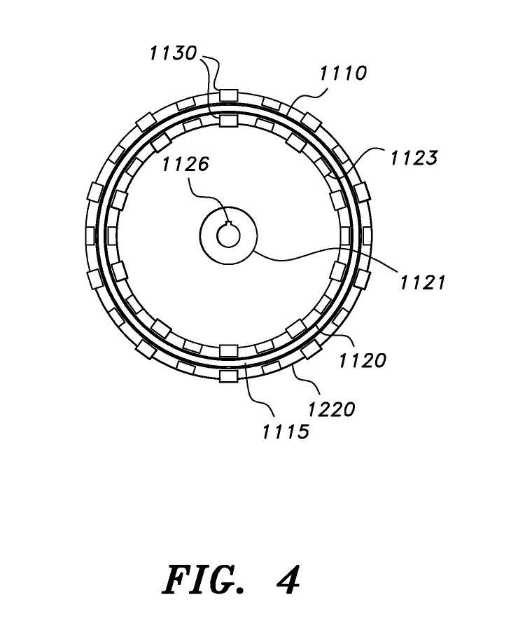

Hub 1121 may include a shaft receiving hole 1124 for mounting inner disk 1120 on the drive shaft of an electric motor or other rotary prime mover. Shaft receiving hole 1124 may include a keyway 1126 (Shown in FIG. 4.), threaded hole 1125 for a set screw 1140, or other means of mounting inner disk 1120 on the drive shaft of a rotary prime mover.

While cylindrical magnets may be easiest to fabricate and result in greater magnetic flux, magnets 1130 may be cylindrical, rectangular, or any other shape known in the art. Magnets 1130 may be of any magnetic material including, but not limited to, ceramics, nickel, and iron.

Magnet receiving blanks 1123 may include means (not shown) for quickly and easily installing magnets 1130. Those means may include cantilevered spring clips, set screws, and any other means known in the art.

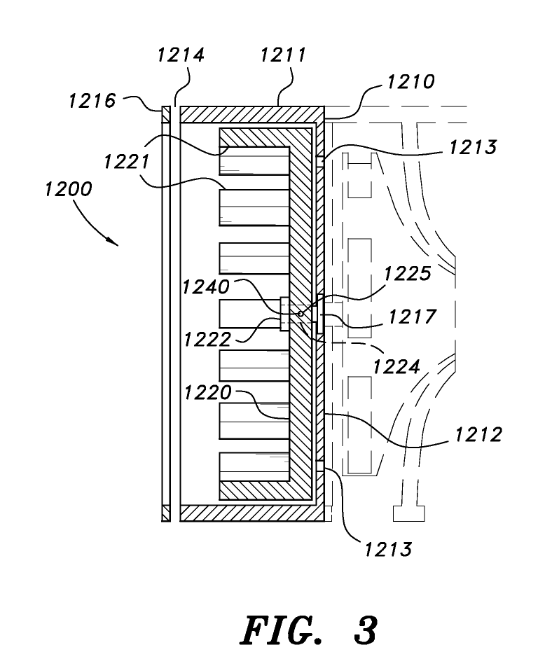

FIG. 3 shows a section view of female module 1200. Female module 1200 may comprise a housing 1210 and a disk coupler 1220.

Housing 1210 may comprise a cylindrical section 1211 and a face 1212. Bolt holes 1213 may be provided in face 1212 for mounting female module 1200 to a component such as a pump or compressor to be driven. Any other means known in the art of mounting a driving element to a driven element may be used.

Clip lock channel 1214 may be provided on a side of cylindrical section 1211 opposite face 1212. Clip lock channel 1214 may facilitate attachment of male module 1100 to female module 1200.

Seal mating face 1216 may be located to mate with an O-ring 1230 inserted into O-ring channel 1113 to provide a fluid-tight seal between male module housing 1110 and female module housing 1210. As an alternative to an O-ring seal, any other means known in the art of providing a fluid-tight seal between static surfaces may be used. Shaft passage 1217 may be provided to allow the shaft of a driven element to pass through when housing 1210 is mounted on the driven component.

Female module housing 1210 may be fabricated of a non-ferromagnetic material including, but not limited to, non-ferrous metal, stainless steel, polymers, carbon fiber, or any other material known in the art to provide minimal interference with magnetic fields.

Disk coupler 1220 may comprise fingers 1221 arranged in a circle centered on a mounting hub 1222. Fingers 1221 may be of a ferromagnetic material. Alternatively, as shown in FIG. 4, disk coupler 1220 may be a disk configured to receive additional magnets 1130 with opposite poles facing the magnets 1130 mounted on inner disk 1120. As an alternative to magnets 1130 mounted in disk coupler 1220, ferromagnetic slugs in the same shape as the magnets 1130 may be inserted into disk coupler 1220. With this arrangement, when male module 1100 rests inside female module 1200, the inner ring of magnets 1130 mounted in male module 1100 exerts an attractive force toward the outer ring of magnets 1130 or ferromagnetic slugs mounted in female module 1200.

If disk coupler 1220 is configured with fingers 1221, the number and angular spacing of fingers 1221 may match the number and angular spacing of magnet receiving blanks 1123. If magnets 1130 or ferromagnetic slugs are used in female module 1200, the number and angular spacing of magnets 1130 or ferromagnetic slugs in male module 1100 may match the number and angular spacing of magnets 1130 used in female module 1200.

Mounting hub 1222 may include a shaft receiving hole 1224 for mounting disk coupler 1220 on the shaft of a rotating component of a compressor, pump, or other fluid moving element. Shaft receiving hole 1224 may include a keyway (not shown), threaded hole 1225 for a set screw 1240, or other means of mounting disk coupler 1220 on the shaft of a rotating component of the compressor, pump, or other fluid moving element.

Installation of modular drive system 1000 onto an electric drive motor and centrifugal compressor will now be described. Although male module 1100 is described as being mounted on the electric motor, and female module 1200 is described as being mounted on the compressor, it is to be understood that the driving and driven modules can be reversed.

A determination may be made as to the amount of power to be transferred. This determination may then be used to determine how many magnets are required in male module 1100 and/or female module 1200. Although male module 1100 has been described as having magnets mounted within, with ferrous fingers 1221 located on female module 1200, removable magnets 1130 may be located on female module 1200, with ferrous fingers located on male module 1100. Installing magnets on both male module 1100 and female module 1200 may allow more power to be transferred between a prime mover and a fluid moving element.

Varying the diameters of inner disk 1120 (and associated elements of male module 1110) and disk coupler 1220 (and associated elements of female module 1210) may vary the amount of torque that may be transferred between the modules. For example, increasing the diameter of the couplers while using the same number of magnetic elements may increase the amount of transferable torque. Increasing diameters of inner disk 1120 and 1220 may also result in greater damping, which may be a factor especially with rotary vane compressors.

Inner disk 1120 may be mounted by inserting the motor shaft receiving hole 1124 and using a key and/or set screw to hold inner disk 1120 on the motor shaft. Housing 1110 may then be bolted onto or otherwise attached to the face of the motor.

Housing 1210 may be bolted or otherwise attached to the driven compressor using a gasket, O-ring, or other method of providing a fluid-tight seal between face 1212 of housing 1210 and a face of the driven compressor. The shaft of the driven compressor may extend through shaft passage 1217 to allow disk coupler 1220 to be mounted on the shaft.

Disk coupler 1220 may be mounted on the shaft of the compressor using a key and/or set screw to hold disk coupler 1220 on the compressor shaft.

Male module 1100 and female module 1200 may be attached to each other using a clip lock or other attachment means known in the art including, but not limited to flanges. In this configuration, magnets 1130 on inner disk 1120 may exert an attractive force on fingers 1221 of disk coupler 1220, causing inner disk 1120 and disk coupler 1220 to rotate together.

The ability to add or remove magnets from inner disk 1120 and/or disk coupler 1220 may allow a user of modular drive system 1000 to vary the number of magnets used in response to the power transfer required. In addition, modular system 1000 may allow multiple fluid moving components (and other rotary components) to be driven by a single motor or other prime mover, assuming each component not located at either end of the stack is provided with a through shaft.

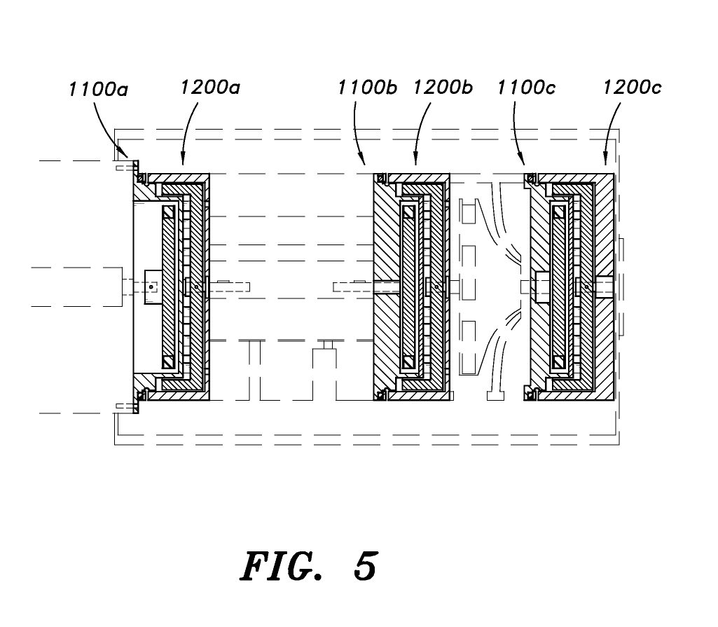

As shown in FIG. 5, multiple elements may be “stacked” linearly, with one end of a shaft being driven by a motor, through a first pair of male module 1100 and female module 1200. The opposite end of the shaft may act as a drive shaft for the next element, with power being transferred through a second pair of male module 1100 and female module 1200.

In FIG. 5, a motor (shown in phantom at the left side of the drawing) may drive a compressor (shown in phantom) through male module 1100a mounted on the motor and female module 1200a mounted on the left side (as shown in drawing) of the compressor. Male module 1100b may be mounted on the right side (as shown in drawing) of the compressor to drive a pump (shown in phantom) through female module 1200b. Male module 1100c may be mounted on the right side of the pump to drive a squirrel cage fan (shown in phantom) through female module 1200c. One or more of the components in the stack may be located inside the squirrel cage fan to save space.

Because more power may be transferred to the first component than to the second component, the number of magnets 1130 required in the first pair of male module 1100a and female module 1200a may be greater than the number of magnets 1130 in the second pair of male module 1100b and female module 1200b, with each pair of modules in the stack having a reduced power transfer requirement as the stack progresses from the motor..

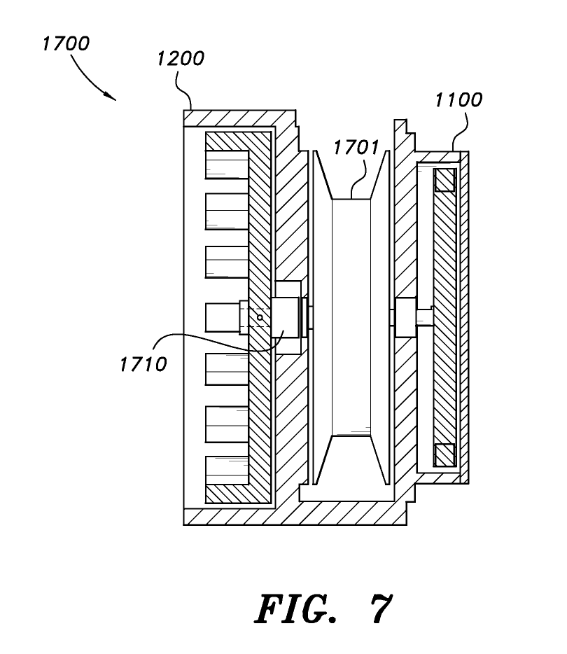

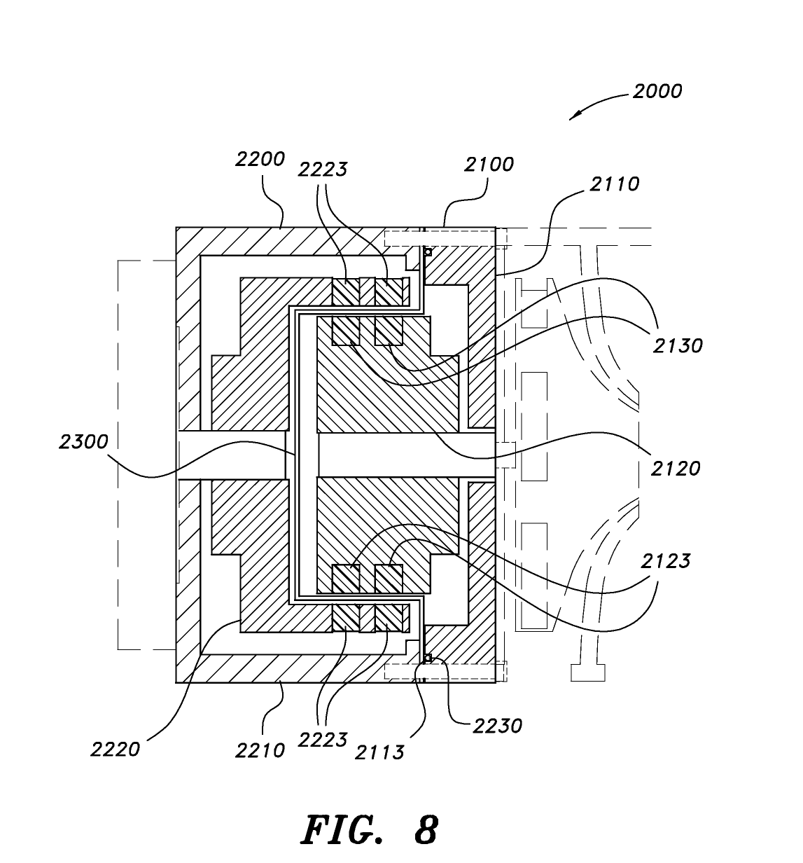

Rather than mounting modules 1100 and 1200 on components, a modular fluid moving element may be used with a built-in female module 1200 on one end and a built in male module 1100 on the other end. Elements other than fluid moving elements may be used in modular form with built in male and female modules to allow “stacking.” For example, FIG. 7 shows a pulley unit 1700 having a built-in male module 1100 and female module 1200. Pulley shaft 1710 may be removable from pulley 1701 to facilitate installation of a belt.

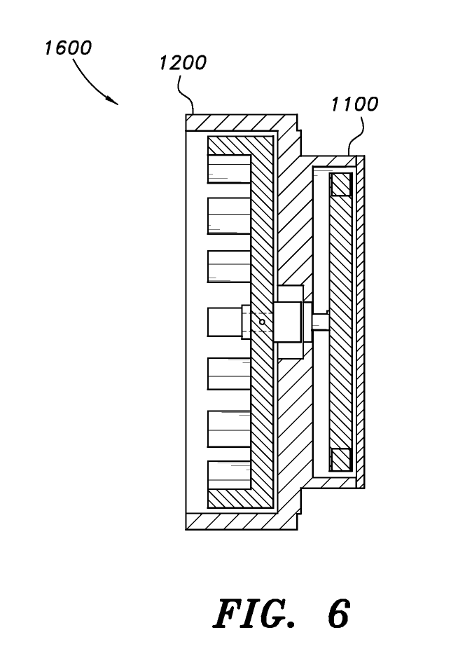

FIG. 6 shows a size adapter module 1800 that may be used to step down to a smaller series of male module 1100 and female module 1200, in the event there is a considerable difference in the power requirement for driving different elements in a “stack” of components.

A number of variations of modular drive system are possible as will be understood by persons of skill in the art. For example, the male module may have a rotary element with ferromagnetic fingers and the female module may have a rotary element with permanent magnets for interacting with the ferromagnetic fingers. Alternatively, the rotary element of the male module may receive ferromagnetic slugs while the rotary element of the female module may receive permanent magnets.

Modular drive system 1000 offers several advantages over current magnetic drives.

One of those advantages is a uniform system for matching a wide variety of components.

Another advantage of modular drive system 1000 is the ability to use only as many magnets as required for the application. This may reduce the cost and weight of a system compared to using a magnetic drive sized to meet the highest expected load.

Yet another advantage of the system is that the concentric arrangement of magnets virtually eliminates the axial thrust load associated with magnetic drives using magnets in a face-to-face arrangement.

It is to be understood that the present invention is not limited to the embodiments described above, but encompasses any and all embodiments within the scope of the following claims.

I claim:

1. A modular magnetic rotary drive system comprising:
a first module comprising a first cylindrical body with a plurality of magnet receiving blanks spaced around a first central hub at equal angles; and
a second module comprising a second cylindrical body with a plurality of fingers spaced around a second central hub at equal angles, the number of fingers being the same as the number of magnet receiving blanks in the first module, wherein
the first module and the second module are adapted to mate together such that the first cylindrical body and the second cylindrical body are capable of rotating about a common axis within a common plane.

2. The modular magnetic rotary drive system according to claim 1, wherein the fingers are fabricated from a ferromagnetic material.

3. The modular magnetic rotary drive system according to claim 1, wherein each finger is configured to receive a permanent magnet.

4. The modular magnetic rotary drive system according to claim 1, further comprising a first housing for containing the first cylindrical body and a second housing for containing the second cylindrical body, wherein the first housing and the second housing are adapted to mate together with a fluid-tight seal.

5. The modular magnetic rotary drive system according to claim 1, adapted to allow a plurality of axially arranged mechanical components to be driven by the same prime mover by using multiple pairs of a first module and a second module.

6. The modular magnetic rotary drive system according to claim 1, further comprising a pulley mounted on a shaft between a first module and a second module, the first cylindrical body and the second cylindrical body also being mounted on the shaft.

7. A modular magnetic rotary drive system comprising:
a first module having a first cylindrical body rotatable about a first hub; and
a second module having a second cylindrical body rotatable about a second hub, wherein
the first cylindrical body and the second cylindrical body are adapted to receive a combination of ferromagnetic elements and permanent magnets that allow synchronous rotation of the first cylindrical body and the second cylindrical body about a common axis due to magnetic attraction in a radial direction with respect to the axis.

8. The modular magnetic rotary drive system according to claim 7, wherein the permanent magnets are removable.

9. The modular magnetic rotary drive system according to claim 7, wherein the first cylindrical body and the second cylindrical body are configured such that permanent magnets and ferromagnetic elements are capable of being received at equal angles about the first cylindrical body and the second cylindrical body.

10. The modular magnetic rotary drive system according to claim 7, wherein the first module further comprises a first housing adapted to mount on the face of a first rotating component while providing a fluid-tight seal, and the second module further comprises a second housing adapted to mount on the face of a second rotating component.

11. The modular magnetic rotary drive system according to claim 10, wherein the first housing and the second housing are adapted to mate to each other with a fluid-tight seal.

12. The modular magnetic rotary drive system according to claim 7, adapted to allow a plurality of axially arranged mechanical components to be driven by the same prime mover by using multiple pairs of a first module and a second module.

13. The modular magnetic rotary drive system according to claim 7, further comprising a pulley mounted on a shaft between a first module and a second module, the first cylindrical body and the second cylindrical body also being mounted on the shaft.

14. A modular magnetic rotary drive system comprising:
a female module comprising a cylindrical body rotatable about a first hub, the cylindrical body having a plurality of blanks, with each blank adapted to receive a permanent magnet; and
a male module comprising a plurality of fingers of a ferromagnetic material arranged in a circle and rotatable about a second hub, wherein
the female module is adapted to be mounted on a first mechanical component having a first rotating shaft;
the male module is adapted to be mounted on a second mechanical component having a second rotating shaft; and
the male module and the female module are adapted to be mated together to transfer power between the first mechanical component and the second mechanical component.

15. The modular magnetic rotary drive system according to claim 14, wherein the male module further comprises a male housing surrounding the plurality of fingers.

16. The modular magnetic rotary drive system according to claim 15, wherein the female module further comprises a female housing surrounding the cylindrical body.

17. The modular magnetic rotary drive system according to claim 16, wherein the female housing is adapted to provide a fluid-tight seal with the second mechanical component.

18. The modular magnetic rotary drive system according to claim 16, wherein the male housing and the female housing are adapted to maintain a fluid-tight seal when mated together.

19. The modular magnetic rotary drive system according to claim 14, adapted to allow a plurality of axially arranged mechanical components to be driven by the same prime mover by using multiple pairs of a first module and a second module.

20. The modular magnetic rotary drive system according to claim 14, further comprising a pulley mounted on a shaft between a first module and a second module, the first cylindrical body and the second cylindrical body also being mounted on the shaft.
